(19) United States
(12) Patent Application Publication
(10) Pub. No.: US 2007/0080011 A1
(43) Pub. Date: Apr. 12, 2007

(54) Apparatus for adjusting force tilting truck cab

(76) Inventor: Jae-Chun Kang, Gwangju (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/299,389

(22) Filed: Dec. 8, 2005

(30) Foreign Application Priority Data
Oct. 7, 2005 (KR) 10-2005-0094268

(51) Int. Cl. B62D 33/00

(52) U.S. Cl. 180/89.14; 180/89.15

(57) ABSTRACT

An apparatus for adjusting a force tilting a truck cab. The apparatus is capable of easily adjusting the torsion angle of a torsion bar between a slightly tilted state and a general state, using an adapter provided between the torsion bar and a tilting arm, without removing the torsion bar from a mounting bracket provided on a truck body, thus simply and safely adjusting a force tilting a truck cab.

### CROSS-REFERENCE TO RELATED APPLICATIONS

The present application is based on, and claims priority to Korean Application Serial Number 10-2005-0094268, filed on Oct. 7, 2005, the disclosure of which is hereby incorporated by reference herein in its entirety.

### FIELD OF THE INVENTION

The present invention relates, in general, to an apparatus for adjusting the force tilting a truck cab and, more particularly, to a technique, intended to more easily adjust the elastic force of a torsion bar in a truck, which is constructed to help tilt a cab using the elastic force of the torsion bar.

### BACKGROUND OF THE INVENTION

In a mechanism for helping tilt a truck cab using elastic force of a torsion bar, one end of the torsion bar, which is arranged in a lateral direction of the truck and serves as a rotating shaft of the cab, is secured to a body of the truck, and the other end of the torsion bar is coupled to a tilting arm. Thus, the tilting arm pushes up the lower portion of the cab, using elastic force of the torsion bar. In a general state where the cab is not tilted (hereinafter referred to as a general state), the cab keeps pressing down the tilting arm through a locking unit installed between the cab and the truck body.

In order to tilt the cab, the locking unit is unlocked so that the cab is rotatable relative to the body. In such a state, energy stored in the torsion bar is transmitted through the tilting arm to the cab, so that the cab maintains a slightly tilted state in which the cab is tilted at about 10 degrees. That is, the slightly tilted state means the state where the cab is tilted by the elastic force of the torsion bar. The tilted angle of the cab varies according to the magnitude of energy accumulated in the torsion bar.

In such a tilted state, the cab is further rotated by human power such that the cab is tilted at an angle of 45 degrees or so. Afterwards, the cab is supported by a stay. Thereby, the operation of tilting the cab is completed.

### SUMMARY OF THE INVENTION

Embodiments of the present invention provide an apparatus for adjusting a force tilting a truck cab, capable of easily adjusting the torsion angle of a torsion bar between a slightly tilted state of a cab and a general state thereof without the having to remove the torsion bar from the mounting bracket of a truck body.

In an apparatus for adjusting a force tilting a truck cab according to an embodiment of the present invention, the number of teeth of a serration coupled to a torsion bar is different from the number of teeth of a serration coupled to a tilting arm, so that an adapter is coupled between the torsion bar and the tilting arm.

### BRIEF DESCRIPTION OF THE DRAWINGS

For a better understanding of the nature and objects of the present invention, reference should be made to the following detailed description with the accompanying drawings, in which:

FIG. 1 illustrates an apparatus for adjusting a force tilting a truck cab, according to the present invention; and

FIG. 2 is a magnified perspective view showing connection parts of the adjusting apparatus of FIG. 1.

### DETAILED DESCRIPTION OF THE PREFERRED EMBODIMENTS

Hereinafter, the preferred embodiment of the present invention will be described with reference to the accompanying drawings.

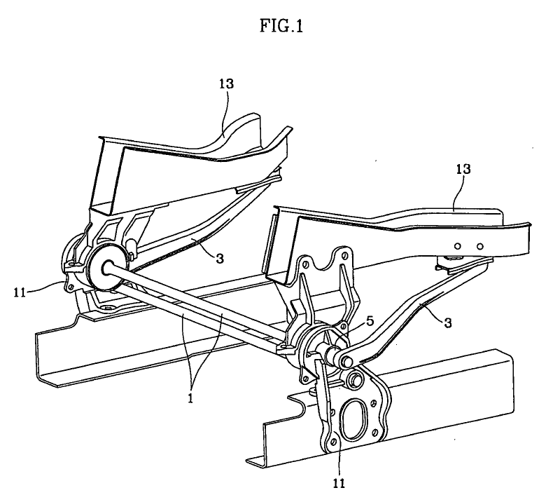

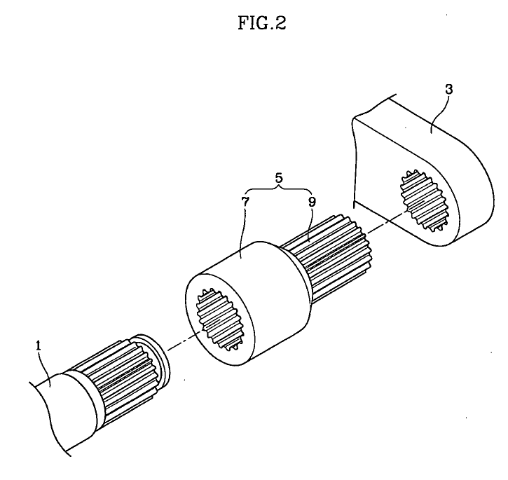

Referring to FIGS. 1 and 2, according to one embodiment of the present invention, the number of teeth of a serration coupled to a torsion bar 1 is different from that of teeth of a serration coupled to a tilting arm 3, so an adapter 5 is coupled between the torsion bar 1 and the tilting arm 3. In FIG. 1, two torsion bars 1 are provided. Opposing ends of the torsion bars 1 are mounted to a truck body using mounting brackets 11, and the remaining ends of the torsion bars 1 are rotatably inserted into other mounting brackets 11 to be supported by the mounting brackets 11. In such a state, the adapter 5 and the tilting arm 3 are sequentially coupled to an associated end of each torsion bar 1. Therefore, cab tilting force is provided by the two torsion bars 1.

In FIG. 1, the cab is omitted, and a floor support member 13 which supports the floor of the cab is supported by the tilting arms 3. According to this embodiment, the adapter 5 includes a female part 7 and a male part 9 which are coaxially arranged and integrated with each other. The female part 7 is coupled to an end of the torsion bar 1 using a serration. The male part 9 is different from the torsion bar 1 with respect to the number of teeth within the serration.

Further, a coupling hole is formed in an end of the torsion bar 1, and a serration is provided inside the end of the torsion bar 1 such that the teeth of the serration protrude. Both sides of the adapter 5 are different from each other with respect to the number of teeth of the serration. In this case, one side of the adapter 5 engages with the coupling hole, and the other side of the adapter 5 engages with a hole formed in the tilting arm 3 using the serrations.

According to one embodiment, the number of teeth of the serration of the female part 7 is larger than that of the male part 9. An example where the female part 7 has 40 teeth and the male part 9 has 37 teeth will be illustrated below.

In order to adjust the torsion angle of the torsion bars 1 between the general state of the cab and the slightly tilted state thereof, a locking unit may be unlocked so that the tilting arms 3 rotates the cab using elastic force accumulated in the torsion bars 1 such that the cab enters the slightly tilted state. Subsequently, the cab may be rotated, and the cab may be secured by using a stay. Thereby, the cab is completely tilted.

In such a tilted state, each tilting arm 3 is spaced apart from the lower surface of the cab, so that the tilting arm 3 and the adapter 5 can be easily removed from the torsion bar 1. When an increase a cab tilting force is desired, the female part 7 of each adapter 5 may be turned relative to an associated torsion bar 1 by one tooth in a clockwise direction, so that the torsion bar 1 may be rotated in a clockwise direction at about 9.0 degrees. Further, when each tilting arm 3 is turned relative to the male part 9 by one tooth in a counterclockwise direction, the tilting arm 3 may be rotated in a counterclockwise direction at about 9.7 degrees. As a result, the torsion bar 1 has further rotated in a counterclockwise direction by about 0.7 degrees. Thus, in the general state of the cab, the torsion bar 1 may accumulate a larger amount of energy corresponding to the torsion of the torsion bar, and may adjust the cab tilting force., in order to reduce or further increase the cab tilting force, the angle of rotation of the tilting arm 3 about the adapter 5 need only be changed, in consideration of the angle of rotation of the adapter 5 about the torsion bar 1.

As apparent from the foregoing, there is an advantage in the present invention in that it is possible to easily adjust the torsion angle of a torsion bar between a slightly tilted state and a general state, using an adapter provided between the torsion bar and a tilting arm, without removing the torsion bar from a mounting bracket provided on a truck body, thus simply and safely adjusting a force tilting a truck cab.

What is claimed is:

1. An apparatus for adjusting a force tilting a truck cab comprising an adapter coupled between a torsion bar and a tilting arm.

2. An apparatus as defined in claim 1, wherein said adapter comprises:
a female part coupled to an end of the torsion bar using a serration;
a male part arranged to be coaxial with the female part, and integrated with the female part, the male part being different from the torsion bar with respect to number of teeth of serration.

3. The apparatus as defined in claim 2, wherein the number of teeth of a serration coupled to a torsion bar is different from the number of teeth of a serration coupled to a tilting arm, so that an adapter is coupled between the torsion bar and the tilting arm.

4. The apparatus as defined in claim 3 wherein the number of the teeth of the serration of the female part is larger than the number of the teeth of the serration of the male part.
